(19) United States
(12) Patent Application Publication
(10) Pub. No.: US 2013/0335669 A1
(43) Pub. Date: Dec. 19, 2013

(54) Liquid Crystal Display Device and Method for Making the Same

(71) Applicants: Shih Hsiang Chen, Shenzhen (CN); Chengwen Que, Shenzhen (CN)

(72) Inventors: Shih Hsiang Chen, Shenzhen (CN); Chengwen Que, Shenzhen (CN)

(73) Assignee: SHENZHEN CHINA STAR OPTOELECTRONICS TECHNOLOGY CO. LTD., Shenzhen (CN)

(21) Appl. No.: 13/574,602

(22) PCT Filed: Jun. 18, 2012
(86) PCT No.: PCT/CN12/77091

§ 371 Date: Jul. 21, 2012

(30) Foreign Application Priority Data
Jun. 13, 2012 (CN) 201210194881.6

(51) Int. Cl. B32B 37/12; G02F 1/1333

(52) U.S. Cl. 349/58; 156/60; 156/275.5

(57) ABSTRACT

The present invention provides a liquid crystal display device and a method for making the same. The liquid crystal display device includes a liquid crystal display panel and a front frame. A glue is arranged between a liquid crystal display panel and the front frame. The glue is further cured and hardened so as to till a gap formed between an edge of the panel and the front frame. By this measurement, automatic production and assembling line can be realized and the yield can be increased and the cost can be lowered.

### FIELD OF THE INVENTION

The present invention relates to a technical field of liquid crystal display, and more particularly, to a liquid crystal display device, and a method for making the same.

Referring to FIG. 1, an illustration and structural view of a prior art liquid crystal display device. As shown in FIG. 1, the prior art liquid crystal display device 10 generally includes a liquid crystal display panel 10, and a front frame 12, and a buffering material 13 is arranged between the panel 11 and the front frame 12 in a way that the panel 11 will not be scratched, and prevent any leakage of light between the panel 11 and the front frame 12. However, with the existing technology, the buffering material 13 is disposed between the panel 11 and the front frame 12 manually and laboriously, and this inevitably increases the manufacturing cost. In addition, when the liquid crystal display device 10 is arranged with a narrowed boarder, the attachment of the buffering material 13 becomes more and more difficult, and the yield is therefore lowered.

### SUMMARY OF THE INVENTION

It is a purpose of the present invention to provide a technical solution by introducing a liquid crystal display device and a method for making the same so as to increase the yield as well as lowering the manufacturing cost.

In order to resolve the technical issue encountered by the prior art, the present invention introduce a technical solution by introducing a liquid crystal display device which includes a liquid crystal display panel and a front frame. The front frame is defined with groove in a surface adjacent to edges of the liquid crystal display panel. The groove is applied and tilled with glue by an automatic glue dispenser and after the glue is cured and hardened, a gap between the panel and the front panel is sealed.

In order to resolve the technical issue encountered by the prior art, the present invention introduce a technical solution by introducing a liquid crystal display device which includes a liquid crystal display panel and a front frame. Wherein a glue is applied between edges of the panel and the front frame, and a gap between the panel and the front frame is sealed after the glue is cured and hardened.

Wherein a surface of the panel adjacent to the edge thereof is defined with groove in which the glue is applied and filled by an automatic glue dispenser such that the glue is cured within the groove.

Wherein the glue is applied to the edge of the panel by an automatic glue dispenser.

Wherein the panel is incorporated with a hook located adjacent to the edge thereof. and the front frame is engaged with the glue by means of the hook.

Wherein the glue is cured by heat or light.

In order to resolve the technical issue encountered by the prior art, the present invention introduce a technical solution by introducing a method for making a liquid crystal display device, wherein the method of making the liquid crystal display device includes the steps of: a) providing a liquid crystal display panel and a front frame; and b) applying glue between the panel and the front frame, and further curing the glue so as to seal a gap located between an edge of the panel and the front frame.

Wherein a surface of the panel adjacent to the edge thereof is defined with groove in which the glue is applied and filled by an automatic glue dispenser such that the glue is cured within the groove.

Wherein the glue is applied to the edge of the panel by an automatic glue dispenser.

Wherein the panel is incorporated with a hook located adjacent to the edge thereof, and the front frame is engaged with the glue by means of the hook.

Wherein the glue is cured by heat or light.

The present invention can be concluded with the following advantages: as compared to the existing prior art, the liquid crystal display device and the method for making the liquid crystal display device provides a genuine and effective way to fill a gap between the panel and the front frame with a glue cured by heat or light. The manufacturing yield can readily be increased, and the cost is therefore reduced.

### BRIEF DESCRIPTION OF DRAWINGS

In order to give a better and thorough understanding to the whole and other intended purposes, features and advantages of the technical solution of the present invention, detailed description will be given with respect to preferred embodiments provided and illustrated herebelow in accompanied drawings. Apparently, with the spirit of the embodiments disclosed, person in the skilled in the art can readily come out with other modifications as well as improvements without undue experiment. In addition, other drawings can be readily achieved based on the disclosed drawings.

FIG. 1 is an illustration and structural view of a prior art liquid crystal display device;

FIG. 2 an illustration and structural view of a liquid crystal display device made in accordance with the first embodiment of the present invention;

FIG. 3 an illustration and structural view of a liquid crystal display device made in accordance with the second embodiment of the present invention;

FIG. 4 is an illustrational view showing an insert of FIG. 3 is arranged between a liquid crystal display panel; and

FIG. 5 is a flow diagram of a method showing steps of making the liquid crystal display device made in accordance with the first embodiment.

### DETAILED DESCRIPTION OF PREFERRED EMBODIMENTS

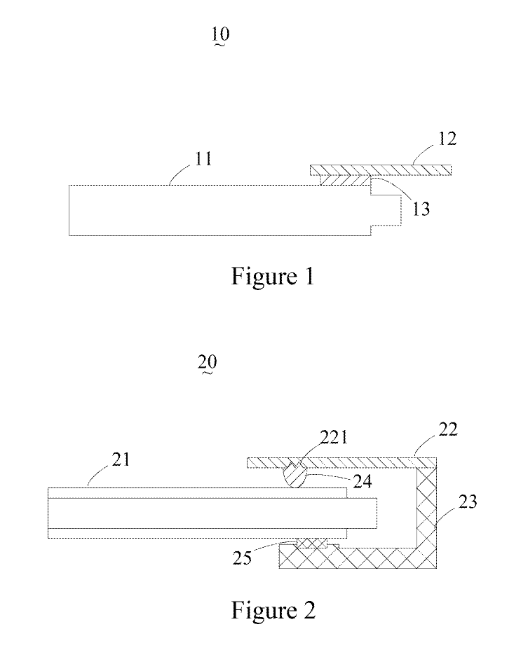

Referring to FIG. 2 which is an illustration and structural view of a liquid crystal display device made in accordance with the first embodiment of the present invention. As shown, the liquid crystal display device 20 in accordance with the present invention includes a liquid crystal display panel 21, a front frame 22, a plastic frame 23, and a glue 24.

In the present embodiment, the liquid crystal display panel 21 is disposed between the plastic frame 23 and the front frame 22. Wherein there is a buffering material 25 disposed between the panel 21 and the plastic frame 23 so as to prevent the panel 21 from sliding around and thereby avoiding breakage of the panel 21.

In the current embodiment, the front frame 22 is defined with a groove 221 adjacent to an edge of the panel 21. An automatic glue dispenser can deploy a certain amount of glue 24 into the groove 221 such that the glue 24 can further cured within the groove 221. The glue 24 can be selected from silicon or polymethyl methacrylate (also known as PM).

A detailed description will be given to the liquid crystal display device 20.

Firstly, the groove 221 is formed in the surface adjacent to the edge of the liquid crystal display panel 21. The automatic glue dispenser is used to deploy the glue 24 along the groove 221. Afterward, the glue 24 is cured. With the automatic glue dispenser, the amount of the glue 24 can be accurately controlled, and a windy path or uneven deployment of the glue 24 can be readily avoided. In addition, since the glue 24 is concentrated within the groove 221, this measurement can readily increase a contact area between the glue 24 and the front frame 22 thereby avoiding any poor adhesion between the glue 24 and the front frame 22.

Secondary, the liquid crystal display panel 21 is mounted onto the plastic frame 23 through the buffering material 25. The front frame 22 is mounted onto the liquid crystal display panel 21. Then the plastic frame 23 and the front frame 22 are secured together. By this arrangement, the liquid crystal display panel 21 is secured between the front frame 22 and the plastic frame 23. Wherein the glue 24 is arranged on the edge of the panel 21 so as to tightly seal the gap fromed between the edge of the panel 21 and the front frame 22. This sealing can effectively prevent the dust and other debris entering into the liquid crystal display device 20. In addition, even this can help to prevent leakage of the light. In addition, on the drop-down test of the liquid crystal display device 20, because the glue 24 provides a decent friction with respect to the panel 21, as a result, the panel 21 will not be damaged resulting from come out of the front frame 22. The risk is therefore lowered.

It should be noted that in the current embodiment, the glue 24 is preferably cured with heat. However, in other preferred embodiment, the skilled in the art can readily appreciated that the glue 24 can be cured with other measurements, such as curing with light.

As compared to the existing technology, the liquid crystal display device 10 provides a genuine and effective way to fill a gap between the panel 21 and the front frame 22 with a glue 24 applied therebetween by the automatic glue dispenser. This arrangement is really beneficial to the automatic production. The production yield can be increased, while the manufacturing cost can be reduced.

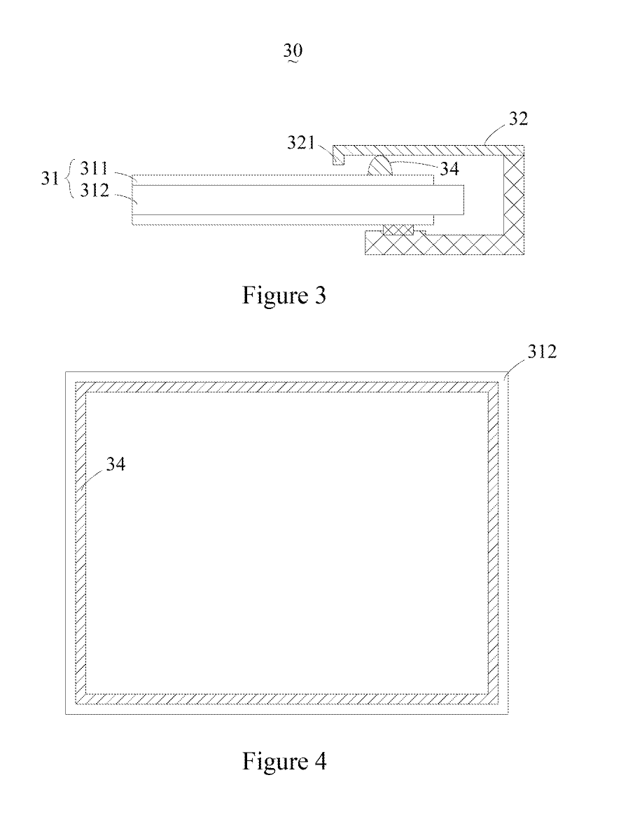

Referring to FIG. 3 which is an illustration and structural view of a liquid crystal display device made in accordance with the second embodiment of the present invention. As shown in FIG. 3, the difference with respect to the first embodiment resides in that in this embodiment, an automatic glue dispenser deploys glue 34 along an edge of a liquid crystal display panel 31 of a liquid crystal display device 30. A front frame 32 is provided with a hook 321 in an area adjacent to the edge of the panel 31. The front frame 32 can be attached to a plastic frame 34 by engagement with the hook 321 so as to tightly seal a gap formed between the panel 31 and the front frame 32. In this preferred embodiment, the liquid crystal display panel 31 includes a polarized plate 311 and a glass substrate 312. The polarized plate 311 is disposed onto a surface of the glass substrate 312. The glue 34 is arranged on the polarized plate 311. In other embodiment, any skilled in the art can readily have the glue 34 arranged onto the glass substrate 312, such as shown in FIG. 4, the glue 34 can be readily deployed onto the glass substrate 312 by the automatic glue dispenser.

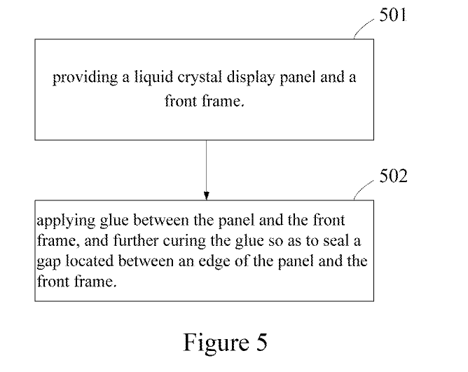

Referring to FIG. 5, which is a flow diagram of a method showing steps of making the liquid crystal display device made in accordance with the first embodiment.

Step 501: a) providing a liquid crystal display panel and a front frame.

Step 502: b) applying glue between the panel and the front frame, and further curing the glue so as to seal a gap located between an edge of the panel and the front frame.

Certain details can be referred to other descriptions given above, as a result, no further disclosure is given herebelow.

In conclusion, the liquid crystal display device and the method of making the same provide a genuine and effective way to fill a gap between the panel and the front frame with a glue applied therebetween by the automatic glue dispenser. This arrangement is really beneficial to the automatic production. The production yield can be increased, while the manufacturing cost can be reduced.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A liquid crystal display device, wherein the liquid crystal display device includes a liquid crystal display panel and a front frame which is defined with groove in a surface adjacent to edges of the liquid crystal display panel, the groove being applied and filled with glue by an automatic glue dispenser, after the glue being cured and hardened, a gap between the panel and the front panel is sealed.

2. A liquid crystal display device, wherein the liquid crystal display device includes a liquid crystal display panel and a front frame, wherein a glue is applied between edges of the panel and the front frame. and a gap between the panel and the front frame is sealed after the glue is cured and hardened.

3. The liquid crystal display device as recited in claim 2, wherein a surface of the panel adjacent to the edge thereof is defined with groove in which the glue is applied and filled by an automatic glue dispenser such that the glue is cured within the groove.

4. The liquid crystal display device as recited in claim 2, wherein the glue is applied to the edge of the panel by an automatic glue dispenser.

5. The liquid crystal display device as recited in claim 4, wherein the panel is incorporated with a hook located adjacent to the edge thereof, and the front frame is engaged with the glue by means of the hook.

6. The liquid crystal display device as recited in claim 2, wherein the glue is cured by heat or light.

7. A method for making a liquid crystal display device, wherein the method of making the liquid crystal display device includes the steps of:
a) providing a liquid crystal display panel and a front frame; and
b) applying glue between the panel and the front frame, and further curing the glue so as to seal a gap located between an edge of the panel and the front frame.

8. The method as recited in claim 7, wherein a surface of the panel adjacent to the edge thereof is defined with groove in which the glue is applied and filled by an automatic glue dispenser such that the glue is cured within the groove.

9. The method as recited in claim 7, wherein the glue is applied to the edge of the panel by an automatic glue dispenser.

10. The method as recited in claim 9, wherein the panel is incorporated with a hook located adjacent to the edge thereof, and the front frame is engaged with the glue by means of the hook.

11. The method as recited in claim 7, wherein the glue is cured by heat or light.
